(19) United States
(12) Patent Application Publication
(10) Pub. No.: US 2008/0004928 A1
(43) Pub. Date: Jan. 3, 2008

(54) MANAGEMENT AND ANALYSIS OF CARGO SHIPMENTS

(76) Inventors: Knut Arne Trellevik, Westmount (CA); Eric Marchand, Montreal (CA); Patrick Blanchette, Montreal (CA); Albert Carbone, St-Lambert (CA)

Correspondence Address: OGILVY RENAULT LLP, 1981 MCGILL COLLEGE AVENUE, SUITE 1600, MONTREAL, QC, H3A2Y3, CA

(21) Appl. No.: 11/753,658

(22) Filed: May 25, 2007

Related U.S. Application Data
(63) Continuation of application No. PCT/CA2006/000931, filed on Jun. 5, 2006.
(60) Provisional application No. 60/686,969, filed on Jun. 3, 2005.

(30) Foreign Application Priority Data
Jun. 5, 2006 (CA) CA2006/000931

(51) Int. Cl. G06Q 10/00

(52) U.S. Cl. 705/7

(57) ABSTRACT

A method for collecting and managing information related to the shipping and condition of a cargo during a cargo voyage from a source to a destination is provided. An electronic cargo voyage folder (ECVF) associated with the cargo is created, including a cargo id, cargo contents and shipping methods for the cargo voyage. At the source a first assessment of an initial cargo condition is requested and the first assessment of the cargo condition, a first place of assessment and a first time of assessment is recorded in the ECVF. The events occurring during the cargo voyage are also recorded in the ECVF. At the destination, a second assessment of the cargo condition is requested and a second assessment of the cargo condition, a second place of assessment and a second time of assessment is recorded in the ECVF.

### CROSS-REFERENCE TO RELATED APPLICATIONS

This application is a Continuation Application, and therefore claims priority from PCT Application no. CA2006/000931 filed on Jun. 5, 2006 which claims priority from U.S. application Ser. No. 60/686,969 filed on Jun. 3, 2005 and entitled MANAGEMENT AND ANALYSIS OF CARGO SHIPMENTS. The whole content of said applications are incorporated by reference into the present application.

### FIELD

The present application relates to a method for collecting, normalizing, disseminating, and analyzing data pertinent to the management of the shipping of cargos, typically in a seagoing environment.

### BACKGROUND

Each voyage of cargo in an international commercial seagoing environment requires a large body of documentation relating to items such as: the source, destination, condition and inventory of the cargo; movement schedules of the cargo and vessel; loading and unloading activities; and the ongoing status of the cargo voyage itself. This documentation is used to manage and document the logistics of the cargo voyage and assign/transfer responsibility and liability between the various parties during the course of the cargo voyage.

The current methods and practices for managing this body of documentation involve many manual steps which are time-consuming and costly for all parties involved. Information and reports are typically communicated between parties by traditional methods such as emails, voice, fax, telex and the physical transfer of paper copies of documents. These methods are error-prone, time-consuming, and do not allow for the rapid dissemination of information among multiple parties. The resulting delays often result in an inability to make critical decisions in a timely manner, or in decisions being made based on incomplete data. Currently there exists no system which allows for the coherent collection and dissemination of the complete information relating to a cargo voyage.

Another problem is caused by the diverse nature of the various documents, both in data content and physical format. The pervasive use of traditional voice, handwritten and other paper forms of communication creates an environment wherein the resulting body of data cannot be analyzed or processed in an automated manner. Certain valuable benefits, such as the ability to simulate possible scenarios based upon the collected body of documentation, and thereby predict and evaluate possible outcomes, are impractical. Currently there exists no system which allows for the coherent collection, normalization and analysis of all of the various documents relating to a cargo voyage.

Additionally, all current systems for tracking shipping operations are oriented towards tracking the movement of the various conveyances used in the cargo voyage: trucks, trains, and seagoing vessels, for example. Tracking of the actual cargo is only performed indirectly by associating the cargo with the conveyance. Currently there exists no system which allows for the tracking and management of the cargo directly in a seagoing shipping environment.

### SUMMARY

According to a first broad aspect, there is provided a method for collecting and managing information related to the shipping and condition of a cargo during a cargo voyage from a source to a destination, comprising: creating an electronic cargo voyage folder associated with the cargo, including a cargo id, cargo contents and shipping methods for said cargo voyage; at said source, requesting a first assessment of an initial cargo condition; recording in said electronic cargo voyage folder said first assessment of said cargo condition, a first place of assessment and a first time of assessment; recording in said electronic cargo voyage folder events occurring during said cargo voyage; at said destination, requesting a second assessment of said cargo condition; and recording in said electronic cargo voyage folder said second assessment of said cargo condition, a second place of assessment and a second time of assessment.

According to a second broad aspect, there is provided a system for collecting and managing information related to the shipping of a cargo during a cargo voyage from a source to a destination, the system comprising: an electronic cargo voyage folder associated with the cargo, including a cargo id, cargo contents and shipping methods for the cargo voyage; a voyage events module for recording in the electronic cargo voyage folder events occurring during the cargo voyage; and a cargo assessment module adapted to request a first assessment of an initial cargo condition and record in the electronic cargo voyage folder the first assessment of the cargo condition, a first place of assessment and a first time of assessment; and request a second assessment of the cargo condition and record in the electronic cargo voyage folder the second assessment cargo condition, a second place of assessment and a second time of assessment.

According to a third broad aspect, there is provided an apparatus for collecting and managing information related to the shipping of a cargo during a cargo voyage from a source to a destination, comprising: a processor; and a memory encoded with processing instructions for allowing the processor to: create an electronic cargo voyage folder associated with the cargo, including a cargo id, cargo contents and shipping methods for the cargo voyage; at the source, request a first assessment of an initial cargo condition; record in the electronic cargo voyage folder the first assessment of the cargo condition, a first place of assessment and a first time of assessment; record in the electronic cargo voyage folder events occurring during the cargo voyage; at the destination, request a second assessment of the cargo condition; and record in the electronic cargo voyage folder the second assessment of the cargo condition, a second place of assessment and a second time of assessment.

According to a fourth broad aspect, there is provided a computer-readable medium encoded with processing instructions for implementing a method, performed by a computer, for collecting and managing information related to the shipping of a cargo during a cargo voyage from a source to a destination, the method comprising: creating an electronic cargo voyage folder associated with the cargo, including a cargo id, cargo contents and shipping methods for the cargo voyage; at the source, requesting a first assessment of an initial cargo condition; recording in the electronic cargo voyage folder the first assessment of the cargo condition, a first place of assessment and a first time of assessment; recording in the electronic cargo voyage folder events occurring during the cargo voyage; at the destination, requesting a second assessment of the cargo condition; and recording in the electronic cargo voyage folder the second assessment of the cargo condition, a second place of assessment and a second time of assessment.

The above-described methods and system facilitate the collection, normalization, dissemination, and analysis of critical cargo voyage-related data for the shipping industry by using a ‘cargo-centric’ paradigm. They also allow critical information at each segment of a cargo voyage to be captured and make it centrally available to various parties. Using the method and system described herein, a transparent documentation process is provided that has the benefit of improving speed and accuracy of decisions relating to a particular cargo. Accountability can more easily be traced in case of damage or loss of a cargo.

### BRIEF DESCRIPTION OF THE DRAWINGS

These and other features and aspects will become better understood with regard to the following description and accompanying drawings wherein:

FIG. 1 is a block diagram of a system for collecting and managing information related to the shipping and condition of a cargo during a cargo voyage according to an embodiment;

FIG. 2 is a flowchart of a typical cargo voyage from a seller to a buyer;

FIG. 3 illustrates an example of a format for storing voyage information for the Electronic cargo voyage folder;

FIG. 4 illustrates an example of a format for storing cargo information for the Electronic cargo voyage folder;

FIG. 5 illustrates an example of a format for storing cargo damage history for the Electronic cargo voyage folder;

FIG. 6 illustrates an example of a format for storing survey information for the Electronic cargo voyage folder;

FIG. 7 illustrates an example of a format for storing voyage event information for the Electronic cargo voyage folder;

FIG. 8 illustrates an example of a format for storing a statement of facts for the Electronic cargo voyage folder;

FIG. 9 illustrates an example of a database structure in a high level design;

FIG. 10 is a diagram of the interaction between various parties and the system for collecting and managing information related to the shipping and condition of a cargo during a cargo voyage according to an embodiment;

FIG. 11 is a screenshot of a user interface for an operator accessing a system for collecting and managing information related to the shipping and condition of a cargo during a cargo voyage according to an embodiment;

FIG. 12 is a screenshot of a user interface for a ship master accessing a system for collecting and managing information related to the shipping and condition of a cargo during a cargo voyage according to an embodiment; and

FIG. 13 is a block diagram of a system in accordance with an embodiment.

### DETAILED DESCRIPTION

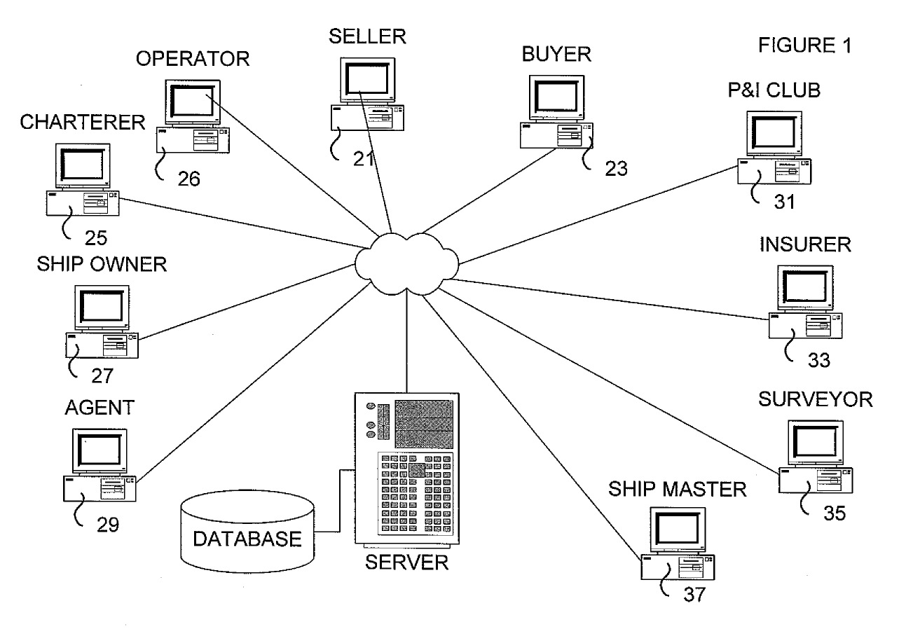

The system of the present application works by creating and maintaining an Electronic cargo voyage folder (ECVF) for each cargo voyage. The contents of the ECVF for a particular cargo are stored on a database, as shown in FIG. 1. As shown, access to the contents of the ECVF is controlled through a server, which is preferably a web server, providing a plurality of users at remote locations with timely information regarding the cargo throughout the cargo voyage. This ECVF serves as a common collection point for all documents and information relating to the voyage, whether created before, during, or after the actual movement of the cargo. Features and benefits of the ECVF in one embodiment include:

Normalization of forms and data elements across all parties involved in the cargo voyage;

Immediate publication of new data to all concerned parties;

Automatic notification messages can be sent to interested parties upon publication of certain information or documents;

Maintaining a permanent audit trail of all documents associated with a cargo voyage;

Maintaining a centralized log of all events occurring during the cargo voyage;

Maintaining a global cargo damage history, showing where and when damages to the cargo occurred and who is responsible according to contract type.

In addition to the speed and efficiency provided by the immediate dissemination of new information, the normalization of data also enables other benefits, provided in one embodiment, such as:

The ability to simulate and calculate various results based on the ECVF data, such as predicting the total cost of a cargo voyage based on parameters extracted from a plurality of sources such as fuel costs, fuel consumption, loading and unloading costs, fees associated with hiring external services, etc.;

The ability to display a graphical timeline for the cargo voyage which incorporates all events of interest to the viewer, both past and predicted;

The ability to analyze data from a single cargo voyage or across a defined set of cargo voyages in order to produce statistical reports.

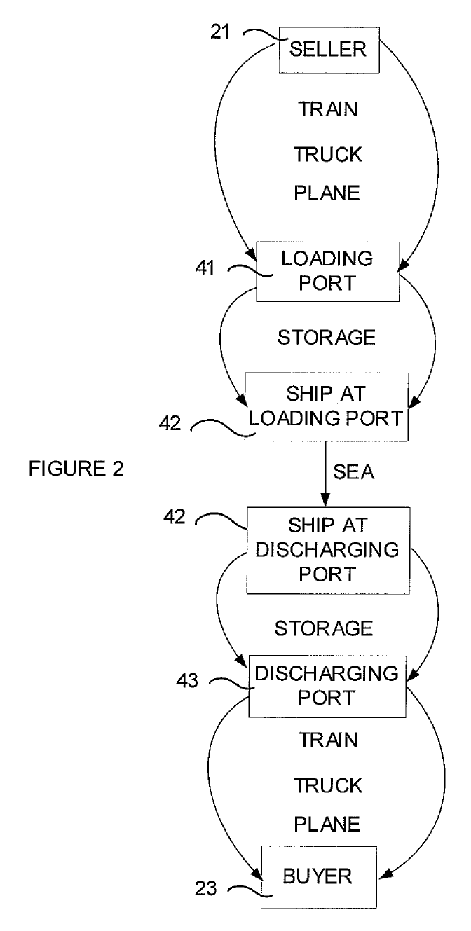

The following example illustrates a typical segment of a cargo voyage and the areas where the system described herein would be used for one embodiment. While the description will be made with respect to a cargo voyage at sea, from a loading port to a discharging port, the sea transportation segment may be part of a more complex cargo voyage, such as illustrated in FIG. 2, including land and/or air transportation, such as by train, vehicle, plane, etc.

The following definitions of the main industry parties will be used in this description:

Charterers: The Charterer 25 identifies business opportunities to buy and sell cargo, works with the sellers and buyers to negotiate purchase prices, and manages the high-level logistics of the cargo voyage.

Operators 26: The Operator manages the low-level logistics of the cargo voyage, including the loading and unloading operations and all necessary inspections and compliance steps.

Ship Owners 27: These are the companies which own the seagoing vessels. The vessel captain (the Master) and crew are direct employees of the Ship Owner.

Surveyors 35: These are independent assessors who inspect and report on the state of both the vessels and cargo. Their reports form the baselines for the state of the vessels and cargo and are used to determine liability in case of damage or loss of the cargo.

Stevedores 79: This is the workforce who physically loads and unloads the cargo at ports.

Agents 29: Working locally in the ports, Agents are facilitators of both paperwork and approvals, and can also arrange for local services such as Surveyors, Harbor Pilots, and Stevedores upon request by the operator. Referring to FIG. 1, other parties that may access information regarding a cargo during a cargo voyage through the system described herein include: Protect & Indemnify (P&l) Club 31, Insurer 33, Seller 21 and Buyer 23. The seller 21 and buyer 23 are the parties selling and buying the cargo being transported. The P&l Club 31 represents a union of industry parties involved in the transportation of the cargo who get together in clubs in order to facilitate interactions for claim settlements.

Cargo Voyage Planning

With respect to FIG. 1, the operator 26 uses the system to build a preliminary ECVF. This ECVF contains details of the cargo and shipping methods for each segment of the cargo voyage, and may be used to simulate the overall costs of the voyage before committing to a specific course of action. The system allows the operator 26 to quickly evaluate various options of shipping methods and routes in order to maximize their profit for the cargo voyage.

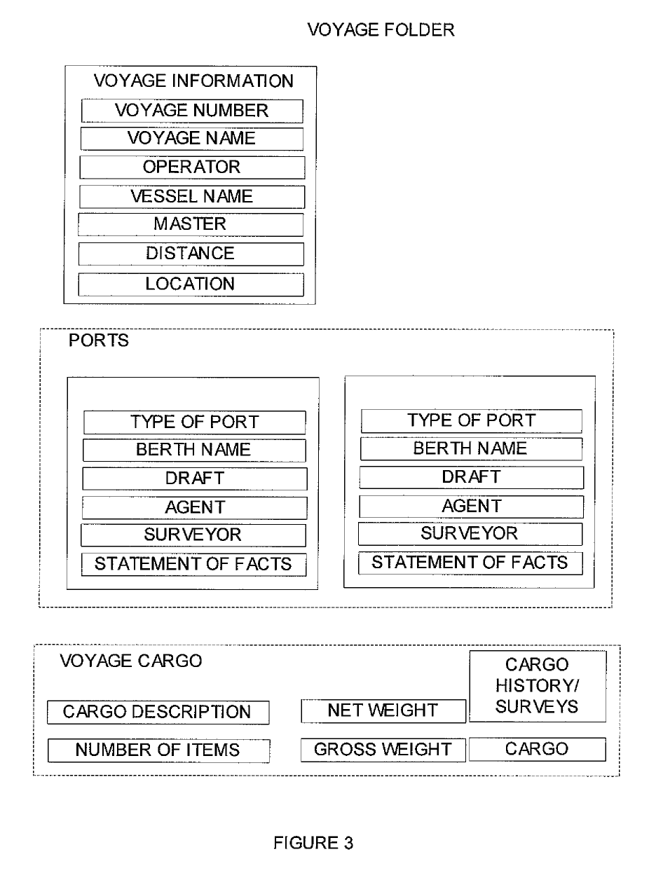

FIGS. 3 to 8 illustrates various parts of the ECVF in an exemplary format. FIG. 3 shows the voyage folder information. Voyage information may be regrouped together and fields are provided for items such as voyage number, voyage name, operator, vessel name, master, distance, and location. Information concerning the ports is also provided and fields are available for the loading port and the discharging port. The cargo may also have its own set of fields for information regrouping the cargo description, number of items, net weight, gross weight, and cargo history/surveys.

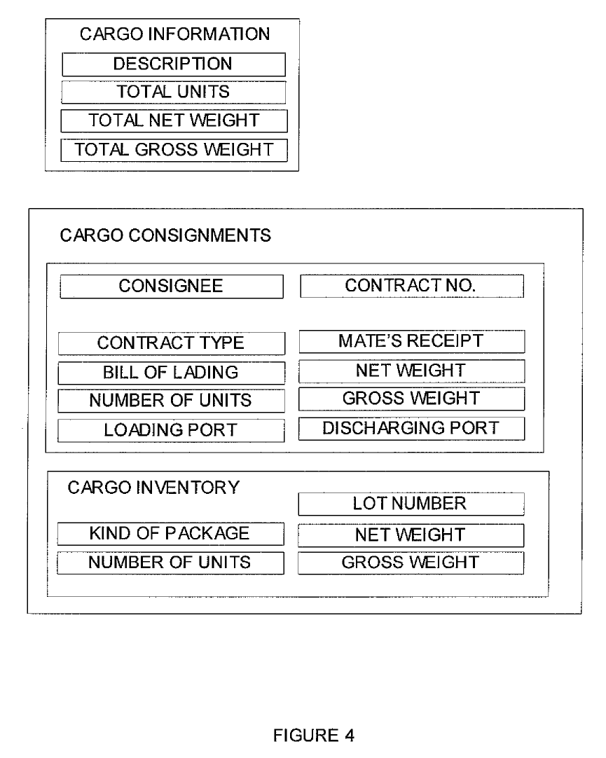

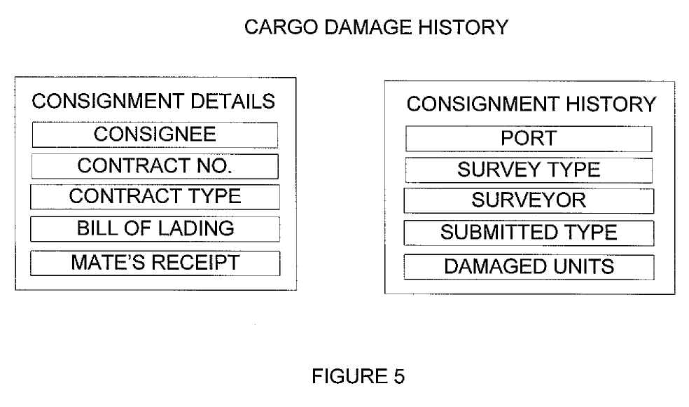

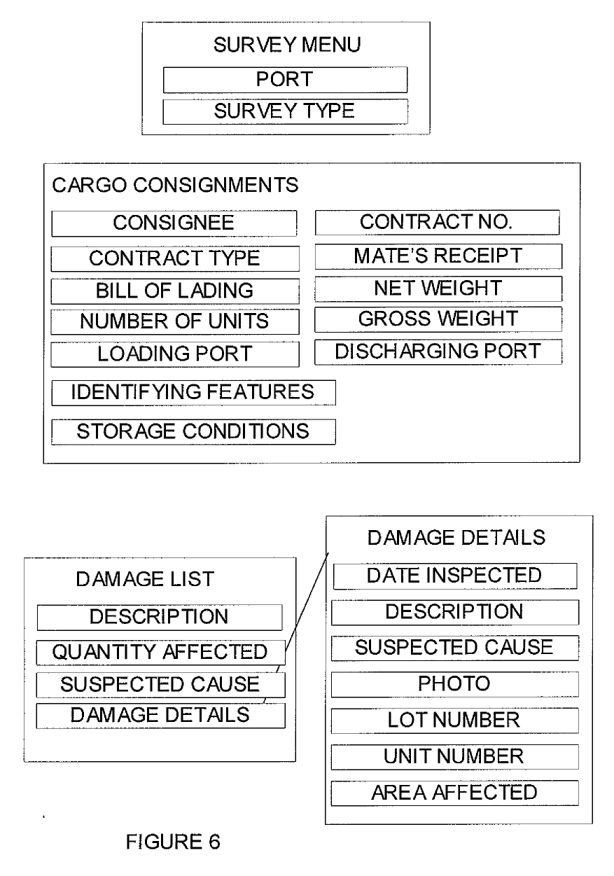

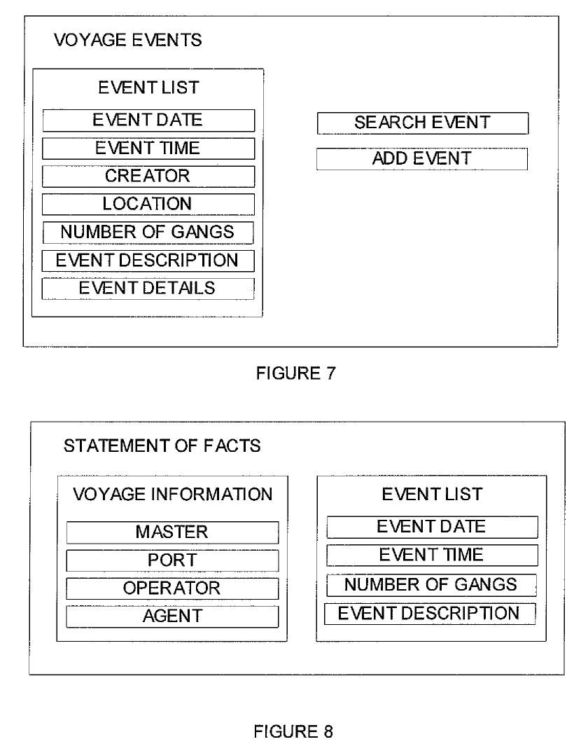

FIG. 4 is more specific information with respect to the cargo. Cargo information such as description, total units, total net weight, and total gross weight is provided. Cargo consignment information, such as consignee number, contract number, and other information relating to the contact as well as the cargo inventory 73 may be provided. FIG. 5 relates to cargo damage history and fields relating to consignment details and consignment history are provided. FIG. 6 illustrates fields related to a survey menu, cargo consignment information, and a damage list. FIG. 7 illustrates fields for information with respect to voyage events, while FIG. 8 illustrates a statement of facts listing.

Cargo Voyage Preparation

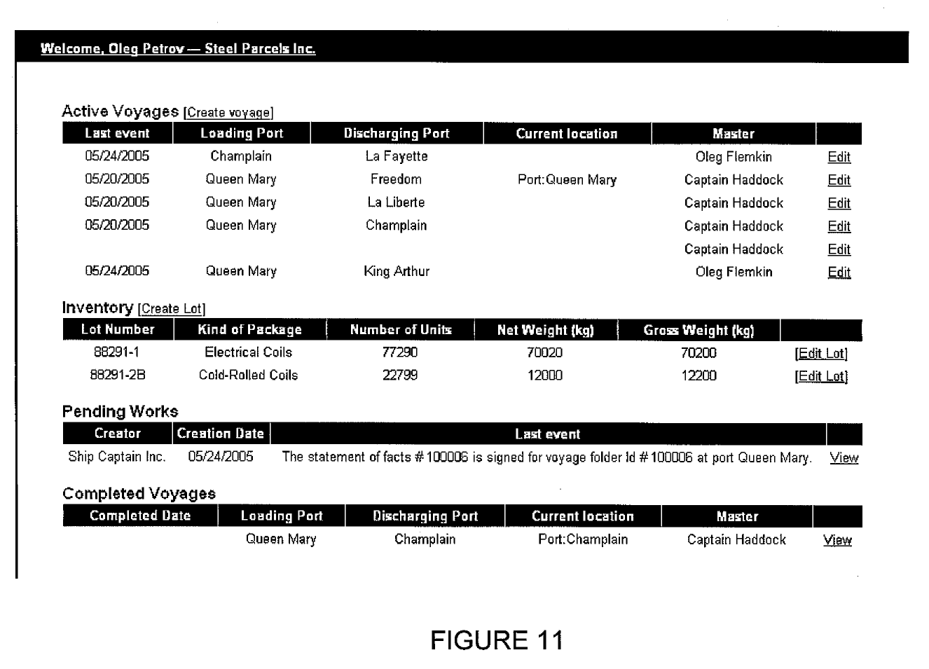

After deciding how to proceed with the cargo voyage, the operator 26 reserves the selected ship using the system as an interface to the shipbroker. Operator 26 uses the system to define the voyage with the loading and unloading port(s) for each cargo consignment 53. With respect to FIG. 11, which is an operator interface to the system, a “create voyage” function allows the operator 26 to select a ship, a loading port, a discharging port and define other parameters of each segment of the voyage.

The operator 26 also uses the system to contact the master 37 of the ship and give him the Voyage Instruction 94, which includes specific logistical details on the cargo 331, ports of call 40, and any agents 29 or other parties contracted by the operator 26.

Ship Arrival at Loading Port

The Master 37 uses the system to send a series of daily Delivery Notices to the Operator 26 and Loading Port Agent 29 indicating the date of arrival of the ship. After arriving at the port, the Master 37 uses the system to send an Arrival Notice to the Operator 26, Loading Port Agent 29 and Ship Owner 27, confirming the arrival of the ship. After docking at the port, the Master 37 uses the system to send a Berth Notice to the Operator 26, Loading Port Agent 29 and Ship Owner 27, confirming the berthing of the ship.

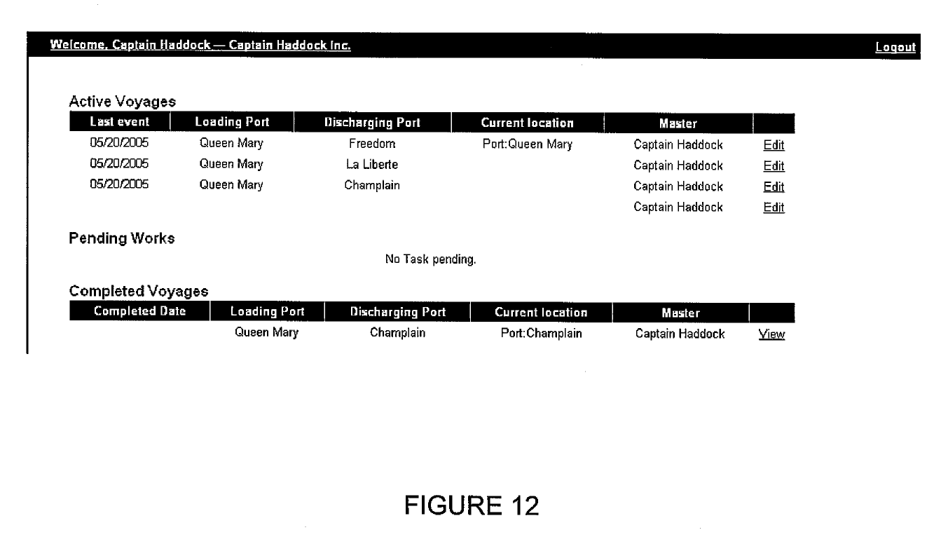

With respect to FIG. 12, which is an example of a master interface to the system, the ship master 27 can view at all times a list of current voyages, completed voyages, as well as pending works, which are requests received from other parties accessing the system.

The Operator 26 uses the system to request a Pre-Loading Survey 60 of the physical condition of the cargo before it is transferred to the ship. The Surveyor 35 having access to the system receives the request and uses the system to complete the Pre-Loading Survey 60 and return it to the Operator 26.

The Operator 26 similarly uses the system to request an On-Hire Survey 64 of the general physical condition of the ship before the cargo 331 is loaded, a Bunker Survey 50 to determine the amount of fuel in the vessel, and a Suitability Survey 66 to verify the vessel's readiness 68 for the intended cargo 331.

The Surveyor 35 having access to the system uses the system to complete the On-Hire Survey 64, Bunker Survey 50, and Suitability Survey 66 and return them to the Operator 26. The Operator 26 uses the system to calculate the amount of additional fuel which will be required in order to complete the cargo voyage.

Loading Process

The Operator 26 uses the system to authorize the Stevedores to begin loading the cargo. The Master 37 uses the system to file a Morning Report each day during the period when the cargo is being loaded.

The Surveyor 35 uses the system to file a Loading Survey 54 each day during the period when the cargo is being loaded. The Operator 26/Agent 29 uses the system to record all pertinent events 91 in the Statement of Facts 451. With respect to FIG. 11, which is an agent interface to the system, the agent 29 can view a list of active voyages as well as a list of pending works, as submitted by other parties. For example, in FIG. 11, the agent receives a request for a statement of facts 451 associated to a particular ECVF.

When the loading process is complete, the Operator 26 uses the system to request a Post-Loading Survey 56 of the physical condition of the loaded cargo. The Surveyor 35 uses the system to complete the Post-Loading Survey 56 and return it to the Operator 26.

Leaving Loading Port

The Master 37 uses the system to file a Sailing Notice. The Loading Port Agent 29 uses the system to file the Mate's Receipt 347, the document traditionally containing information regarding the cargo and used as an acknowledgement that the master 37 has received the cargo in the condition stated therein. The master 37 uses the system to approve the Mate's Receipt 347. The Loading Port Agent 29 uses the system to file the Bill of Lading.

Bunkering (Fueling)

If required, the vessel will sail to a fueling facility to take on additional fuel. The Master uses the system to send a series of daily Estimated Time of Arrivals (ETAs) to the Bunkering Company indicating the date of arrival of the ship.

At Sea

The vessel begins sailing to the destination (discharging) port. The Master 37 uses the system to file daily Noon Reports 77 on the status of the vessel and progress of the cargo voyage.

At Discharging Port

After arriving at the port, the Master 37 uses the system to send an Arrival Notice to the Operator 26, Discharging Port Agent 29 and Ship Owner 27, confirming the arrival of the ship. After docking at the port, the Master 37 uses the system to send a Berth Notice to the Operator 26, Discharging Port Agent 29 and Ship Owner 27, confirming the berthing of the ship.

The Operator 26 and/or Ship Owner 27 uses the system to request a Pre-Discharge Survey 58 and/or Cargo Damage Report 55 of the physical condition of the cargo before it is transferred off the ship. The Surveyor 35 uses the system to complete the Pre-Discharge Survey and/or Cargo Damage Report 55 and return it to the requester.

Discharging Process

The Operator 26 uses the system to authorize the Stevedores to begin unloading the cargo. The Master uses the system to file a Morning Report each day during the period when the cargo is being unloaded.

The Surveyor 35 uses the system to file a Discharge Report 52 each day during the period when the cargo is being unloaded.

The Operator 26/Agent 29 uses the system to record all pertinent events in the Statement of Facts 451. The Operator 26 continues to use the system to record the details of the delivery of the cargo to its final destination.

Returning the Vessel to the Owner

The Ship Owner 27 uses the system to request a Redelivery Survey 62 of the vessel prior to taking back possession. The Surveyor 35 uses the system to complete the Redelivery Survey and return it to the Ship Owner 27. The Ship Owner 27 then assumes possession of the vessel.

In one embodiment, the system may be used for claim management. Due to the nature of the business, responsibility for the cargo is being transferred from one party to another throughout the cargo voyage. The actual result is that complex contracts exist between the different parties involved in order to insure the responsible person, and delays or damages end up being paid by the proper party (or its insurer). The following are some types of claims for which the information gathered and centralized by the system and method described herein can be useful in managing:

1. Demurrage/Dispatch claims: claims relating to longer time to load ship.

2. Damage (physical) claims: damage to cargo in one of the step of the transport from the seller to the buyer.

3. Speed claims: since the Charterer 25 typically pays the ship on a day-by-day basis, delays from the original number of days to go from loading port to discharge port may result in a speed claim.

By recording assessments of the cargo condition at different places and times, responsibility and liability can be accurately determined and the claims management process is greatly simplified.

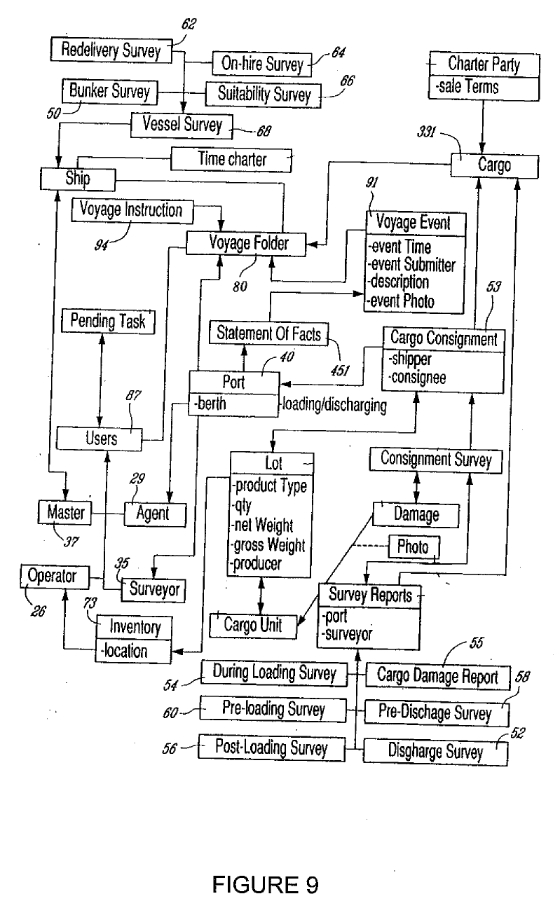

FIG. 9 is an example of a database structure for an embodiment of the present system and method, designed using Unified Modeling Language (UML), an object-oriented analysis and design language from the Object Management Group.

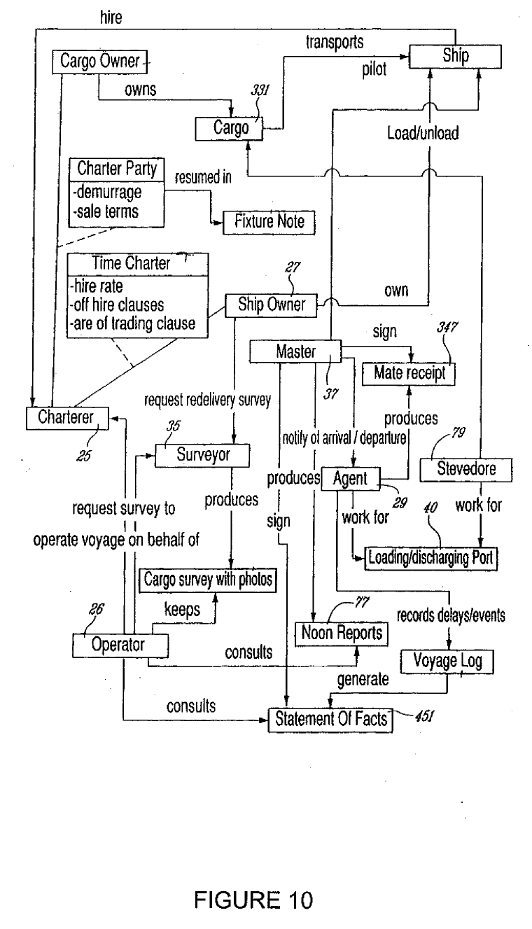

FIG. 10 is an example of the interactions between the different entities in the system/method. The entities include people involved, such as the Master, the Ship Owner, the Stevedores, the Operator, and the Charterer 25, as well as organizations and objects, such as a vessel, a cargo, a port, etc.

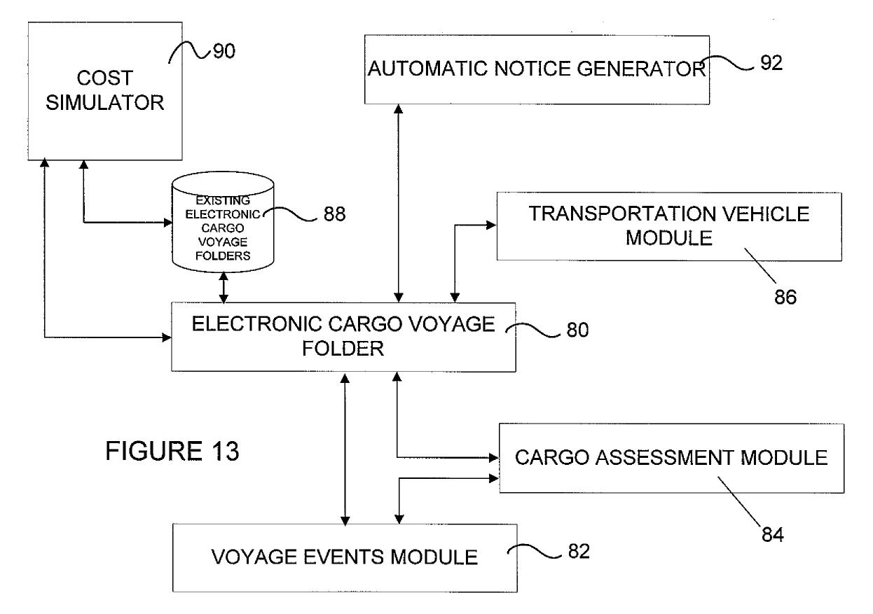

FIG. 13 is an exemplary block diagram of a system in accordance with an embodiment. A database 88 holds all existing cargo folders with past, present, and future voyages. The electronic cargo voyage folder 80 is part of this database and is where all information relating to the particular voyage, as illustrated in FIGS. 3 to 8, is stored. A voyage events module 82 allows a user 87 of the system to record in the electronic cargo voyage folder 80 any events occurring during the voyage.

A cargo assessment module 84 is adapted to request a first assessment of an initial cargo condition and record in the electronic cargo voyage folder 80 the first assessment of the cargo condition, a first place of assessment and a first time of assessment. It also requests a second assessment of the cargo condition and records in the electronic cargo voyage folder 80 the second assessment cargo condition, a second place of assessment and a second time of assessment. The cargo assessment module can also compare the second assessment of the final cargo condition with the first assessment of the cargo condition to determine a difference in the cargo condition. This can be used for claim management and to determine responsibility for any potential damage to the cargo. The cargo assessment module 84 can use information from the voyage events module 82 to determine if an event in particular may have had an impact on the cargo and who was responsible for the cargo at the time of the event. Events can be recorded pre-loading, during loading, post-loading, during unloading, and post-unloading of the cargo.

A transportation vehicle module 86 can be used to provide and to enter information as to the availability of a transportation vehicle for loading the cargo and for recording in the electronic cargo voyage folder 80 an assessment of the transportation vehicle condition, an authorization for cargo loading according to the assessment of the transportation vehicle, an authorization for cargo unloading at the destination, and an assessment of the transportation vehicle condition at the destination. The transportation vehicle can be, for example, a sea vessel such as a ship, or any other type of transportation vehicle such as a truck, train, or airplane.

Various notices may be generated by the automatic notice generator 92 at any moment during the voyage. This should be understood to include the time preceding loading the cargo, starting with voyage preparation and ending with any post-discharging processes or assessments that have to be made or claims to be filed. Examples of the notices are listed above. The notices may be formal letters pre-stored in the system and simply accessed by the user, or they may be created by the user at each instance. The generation of the notices can be triggered by a field being filled in the electronic cargo voyage folder 80, or by an event being entered in the voyage events module 82. The user can also trigger manually the generation of the notices when needed. Information to complete fields of already prepared notices can be retrieved from the electronic cargo voyage folder 80, such as dates, names, times, etc. Other notices, in addition to the ones listed above, can be generated by the automatic notice generator 92 and it should be understood by a person skilled in the art that the list presented herewith is non-exhaustive.

A cost simulator 90 can be used to simulate costs for an overall voyage using information of past cargo voyages from already existing voyage folders.

While illustrated in the block diagrams as groups of discrete components communicating with each other via distinct data signal connections, it will be understood by those skilled in the art that the preferred embodiments are provided by a combination of hardware and software components, with some components being implemented by a given function or operation of a hardware or software system, and many of the data paths illustrated being implemented by data communication within a computer application or operating system. The structure illustrated is thus provided for efficiency of teaching the present preferred embodiment.

It should be noted that the present application can be carried out as a method, can be embodied in a system, a computer readable medium or an electrical or electro-magnetic signal. The embodiment(s) of the application described above is(are) intended to be exemplary only. The scope is therefore intended to be limited solely by the scope of the appended claims.

What is claimed is:

1. In a network comprising a database and a server, said network being accessible by multiple parties, a method for collecting and managing information related to the shipping of a cargo during a cargo voyage from a source to a destination, comprising:
storing in said database an electronic cargo voyage folder associated with the cargo, and comprising a cargo id, cargo contents and shipping methods for said cargo voyage;
at said source, at least one of said parties requesting a first survey of a cargo condition through said server;
recording in said electronic cargo voyage folder said first survey, a first place of survey and a first time of survey;
at said destination, at least one of said parties requesting a second survey of another cargo condition through said server; and
recording in said electronic cargo voyage folder said second survey, a second place of survey and a second time of survey;
said server comparing said second survey with said first survey to determine a difference between said cargo conditions; and
said server using said difference and said information regarding said places of surveys and said times of surveys to determine a party responsible for said difference in a claim management process.

2. A method as claimed in claim 1, further comprising:
said server receiving, from at least one of the parties, information as to the availability of a transportation vehicle for loading said cargo at said source;
at least one of said parties requesting a survey of said transportation vehicle condition through said server;
recording said first survey of said transportation vehicle condition in said electronic cargo voyage folder;
providing authorization for cargo loading according to said first survey of said transportation vehicle condition;
at said destination, providing authorization for cargo unloading;
at least one of said parties requesting a second survey of said transportation vehicle condition through said server;
recording said second survey of said transportation vehicle condition in said electronic cargo voyage folder.

3. A method as claimed in claim 1, wherein said voyage comprises an intermediary segment of an overall voyage, said overall voyage for transporting said cargo from an initial source to a final destination.

4. A method as claimed in claim 2, wherein said transportation vehicle comprises a sea vessel.

5. A method as claimed in any one of claim 1, further comprising said server selecting a specific course of action for said cargo voyage from a prediction of overall costs based on information of past cargo voyages stored in already existing electronic cargo voyage folders.

6. A method as claimed in any one of claim 1, further comprising creating and recording a voyage for said cargo in said electronic cargo voyage folder comprising selecting a transportation vehicle, a loading port, and a discharging port.

7. A method as claimed in any one of claim 6, wherein said creating a voyage comprises recording details on said cargo, ports of call, and parties contacted by an operator for said voyage.

8. A method as claimed in any one of claim 1, further comprising said server generating notices concerning a progress of said cargo voyage.

9. A method as claimed in claim 8, wherein said notices comprise at least one of: a delivery notice to indicate a date of arrival of said cargo to said parties, an arrival notice to confirm an arrival of said cargo to said parties and a Berth notice to confirm berthing of said cargo to said parties.

10. A method as claimed in any one of claim 1, further comprising recording in said electronic cargo voyage folder events occurring during said cargo voyage.

11. An apparatus for collecting and managing information related to the shipping of a cargo during a cargo voyage from a source to a destination, comprising:
a database adapted to be accessible by a processor and multiple external parties;
a processor; and
a memory encoded with processing instructions for allowing the processor to:
create an electronic cargo voyage folder associated with the cargo;
store in said database said electronic cargo voyage folder comprising a cargo id, cargo contents and shipping methods for said cargo voyage;
at said source, receive a request for a first survey of a cargo condition from at least one of said parties;
record in said electronic cargo voyage folder said first survey, a first place of survey and a first time of survey;
at said destination, receive a request for a second survey of another cargo condition from at least one of said parties; record in said electronic cargo voyage folder said second survey, a second place of survey and a second time of survey;
compare said second survey with said first survey to determine a difference between said cargo conditions; and
use said difference and said information regarding said places of surveys and said times of surveys to determine a party responsible for said difference in a claims management process.

12. A computer-readable medium encoded with processing instructions for implementing a method, performed by a computer, for collecting and managing information related to the shipping of a cargo during a cargo voyage from a source to a destination, the method comprising:
creating and storing in a database accessible by multiple parties and said computer an electronic cargo voyage folder associated with the cargo, including a cargo id, cargo contents and shipping methods for said cargo voyage;
at said source, receiving a request for a first survey of a cargo condition from at least one of said parties;
recording in said electronic cargo voyage folder said first survey, a first place of survey and a first time of survey;
at said destination, receiving a request for a second survey of another cargo condition from at least one of said parties;
recording in said electronic cargo voyage folder said second survey, a second place of survey and a second time of survey;
comparing said second survey with said first survey to determine a difference between said cargo conditions; and
using said difference and said information regarding said places of surveys and said times of surveys to determine a party responsible for said difference in a claims management process.

13. A system for collecting and managing information related to the shipping of a cargo during a cargo voyage from a source to a destination, the system comprising:
an electronic cargo voyage folder associated with the cargo, stored in a database accessible by multiple parties and comprising a cargo id, cargo contents and shipping methods for said cargo voyage; and
a cargo survey module adapted to
request a first survey of a cargo condition and record in said electronic cargo voyage folder said first survey, a first place of survey and a first time of survey upon receiving a first survey request from at least one of said parties;
request a second survey of another cargo condition and record in said electronic cargo voyage folder said second survey, a second place of survey and a second time of survey upon receiving a second survey request from at least one of said parties;
compare said second survey with said first survey to determine a difference between said cargo conditions; and
use said difference and said information regarding said places of surveys and said times of surveys to determine a party responsible for said difference in a claims management process.

14. A system as claimed in claim 12, further comprising a transportation vehicle module adapted to provide information as to the availability of a transportation vehicle for loading said cargo and for recording in said electronic cargo voyage folder a survey of said transportation vehicle condition, an authorization for cargo loading according to said survey of said transportation vehicle, an authorization for cargo unloading at said destination, and a survey of said transportation vehicle condition at said destination.

15. A system as claimed in any one of claim 12, further comprising a cost simulator for predicting costs for an overall voyage based on information of past cargo voyages stored in already existing electronic cargo voyage folders to select a specific course of action for said cargo voyage.

16. A system as claimed in any one of claim 12, further comprising an automatic notice generator for generating notices concerning said cargo voyage to parties involved in said cargo voyage.

17. A system as claimed in claim 15, wherein said notices are selected from a list comprising of at least one of daily delivery notices, arrival notices, berthing notices, authorization notices, and Mate's receipt notices.

18. A system as claimed in any one of claim 13, further comprising a voyage events module for recording in said electronic cargo voyage folder events occurring during said cargo voyage.

19. An apparatus as claimed in claim 11, further wherein said memory is encoded with processing instructions for allowing the processor to:
record in said electronic cargo voyage folder events occurring during said cargo voyage.

20. A computer-readable as claimed in claim 12, wherein the method further comprises recording in said electronic cargo voyage folder events occurring during said cargo voyage.
